(19) United States
(12) Patent Application Publication
(10) Pub. No.: US 2025/0343245 A1
(43) Pub. Date: Nov. 6, 2025

(54) CATHODE FOR SECONDARY BATTERY AND LITHIUM SECONDARY BATTERY

(71) Applicant: SK ON CO., LTD., Seoul (KR)

(72) Inventors: Chan Woo KOO, Daejeon (KR); Sang Han LEE, Daejeon (KR); Sang Wook LEE, Daejeon (KR); Eun Bi KIM, Daejeon (KR); Yoon Ji LEE, Daejeon (KR); Byoung Beom LIM, Daejeon (KR)

(21) Appl. No.: 19/197,603

(22) Filed: May 2, 2025

(30) Foreign Application Priority Data
May 2, 2024 (KR) 10-2024-0058544

(51) Int. Cl. H01M 4/62; H01M 4/525; H01M 10/052

(52) U.S. Cl. CPC H01M 4/628; H01M 4/525; H01M 10/052

(57) ABSTRACT

A cathode for a secondary battery according to embodiments of the present disclosure includes a cathode current collector and a cathode active material layer. The cathode active material layer is disposed on at least one surface of the cathode current collector and includes lithium metal oxide particles containing a doping metal. The cathode has an activation energy (Ea) of 62.5 to 66 kJ/mol, as represented by Equation 1.

### CROSS-REFERENCES TO RELATED APPLICATION

The present application claims priority under 35 U.S.C. 119 (a) to Korean patent application number 10-2024-0058544 filed on May 2, 2024, in the Korean Intellectual Property Office, the entire disclosure of which is incorporated by reference herein.

### BACKGROUND

### 1. Field

The present invention provides a cathode for a lithium secondary battery and a lithium secondary battery.

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as an electric vehicle, a hybrid vehicle, etc., as their power sources.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are housed.

A lithium metal oxide is used as an active material for the cathode of a lithium secondary battery, and it is preferable that the active material exhibits high capacity, high output, and high cycle life characteristics. Accordingly, research is being conducted to improve the capacity characteristics by increasing the nickel content.

However, a high-nickel lithium metal oxide exhibits low structural and thermal stability, and thus, the performance of the cell may deteriorate during repeated charge and discharge cycles.

Therefore, in order to implement a battery having high capacity and high stability, it is necessary to develop a technology that can enhance the stability of the cathode active material.

### SUMMARY

An embodiment of the present disclosure provides a cathode for a secondary battery with improved electrochemical characteristics.

Another embodiment of the present disclosure provides a lithium secondary battery including the cathode.

A cathode for a secondary battery according to exemplary embodiments of the present disclosure includes a cathode current collector and a cathode active material layer. The cathode active material layer is disposed on at least one surface of the cathode current collector and includes lithium metal oxide particles containing a doping metal. The cathode has an activation energy (Ea) of 62.5 to 66 kJ/mol, as represented by Equation 1 below.

$$ln {R}^{′} = ln {R}_{0} - \frac{E a}{R} \cdot \frac{1}{T} \qquad [ Equation 1 ]$$

In Equation 1 above, R′ represents the total charge transfer resistance (Rct) obtained by analyzing a half-cell including the cathode and a lithium metal foil counter electrode, modeled as a Randles circuit at two or more different temperatures using electrochemical impedance spectroscopy (EIS). T represents the temperature (K) in the environment at which the EIS analysis is performed. In R₀ and −Ea/R represent the intercept and slope, respectively, derived from a plot of ln R′ versus 1/T according to Equation 1. R₀ represents a constant resistance value independent of temperature, and R represents the gas constant (8.314 J/mol·K)).

According to exemplary embodiments, the doping metal may include at least one selected from the group consisting of Al, Ti, Ba, Zr, Si, B, Mg, P, Sr, W and Y.

According to exemplary embodiments, the doping metal may include at least one selected from the group consisting of Ti, Ba, Zr, Si, Mg, Sr, W and Y.

According to exemplary embodiments, the content of the doping metal may be 1000 ppm to 3000 ppm based on the total weight of the lithium metal oxide particles.

According to exemplary embodiments, the lithium metal oxide particles may include nickel, and the molar fraction of nickel among metals excluding lithium and oxygen of the lithium metal oxide particles may be 0.8 or more.

According to exemplary embodiments, the lithium metal oxide particles may have a layered structure represented by Formula 1 below:

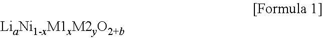

In Formula 1 above, M1 includes at least one of Co and Mn, and M2 includes at least one selected from the group consisting of Al, Ti, Ba, Zr, Si, B, Mg, P, Sr, and W, and a, x, y and b satisfy 0.9≤a≤1.1, 0≤x≤0.2, 0<y≤0.01, and −0.5≤b≤0.5.

According to exemplary embodiments, the doping metal may be present in a central portion of the lithium metal oxide particle.

According to exemplary embodiments, the doping metal may not exhibit a concentration gradient from the central portion to a surface portion of the lithium metal oxide particle.

According to exemplary embodiments, the lithium metal oxide particle may have a crystal grain size of 100 nm to 200 nm, as measured by X-ray diffraction (XRD) analysis.

According to exemplary embodiments, the R′ value according to Equation 1 at 283 K may be 40% or less of the R′ value according to Equation 1 at 273 K.

According to exemplary embodiments, the R′ value according to Equation 1 at 283 K may be 20% to 38% of the R′ value according to Equation 1 at 273 K.

A lithium secondary battery according to exemplary embodiments of the present disclosure includes the cathode and an anode disposed opposite to the cathode.

The internal resistance of the cathode for a secondary battery according to exemplary embodiments of the present disclosure may be reduced, thereby allowing lithium ions to migrate smoothly. Accordingly, a battery with improved output characteristics may be implemented.

The resistance characteristics of the cathode for a secondary battery according to exemplary embodiments of the present disclosure may be improved under low-temperature conditions, and the operational reliability of the battery may be ensured even under extreme conditions.

The lithium secondary battery according to exemplary embodiments of the present disclosure may exhibit enhanced output and cycle life characteristics by including the cathode.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating a cathode for a secondary battery according to exemplary embodiments;

FIG. 2 is a circuit diagram illustrating a Randles circuit according to exemplary embodiments; and

FIGS. 3 and 4 are schematic cross-sectional and plan views, respectively, illustrating a lithium secondary battery according to exemplary embodiments.

### DETAILED DESCRIPTION

According to exemplary embodiments of the present disclosure, there is provided a cathode for a secondary battery having an activation energy (Ea) of 62.5 to 66 kJ/mol, as represented by Equation 1 below.

In addition, there is provided a lithium secondary battery including the cathode.

Hereinafter, embodiments of the present disclosure will be described in detail with reference to the accompanying drawings. However, these embodiments are merely examples, and the present disclosure is not limited to the specific embodiments described as examples.

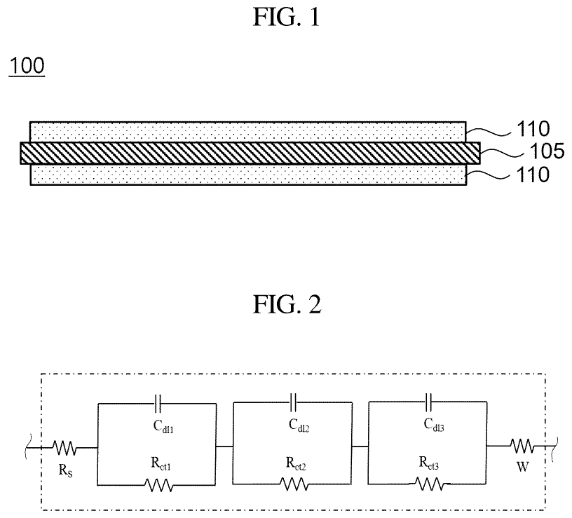

FIG. 1 is a schematic cross-sectional view illustrating a cathode for a secondary battery according to exemplary embodiments.

Referring to FIG. 1, a cathode 100 for a secondary battery includes a cathode current collector 105 and a cathode active material layer 110 formed on at least one surface of the cathode current collector 105.

For example, the cathode active material layer 110 may be formed on one surface or both surfaces of the cathode current collector 105.

The cathode current collector 105 may include, for example, stainless steel, nickel, aluminum, titanium, copper, or an alloy thereof.

The cathode active material layer 110 may include a cathode active material. The cathode active material may include lithium metal oxide particles. The lithium metal oxide particles may contain a doping metal.

The lithium metal oxide may include nickel. Nickel may be provided as a transition metal associated with the output and capacity of the lithium secondary battery. Therefore, as described above, by employing a high-nickel-content (high-Ni) composition in the lithium metal oxide particles, a high-power cathode and a high-power lithium secondary battery may be provided. However, as the content of nickel increases, the long-term storage stability and cycle life stability of the cathode or the secondary battery may be relatively degraded.

Therefore, according to exemplary embodiments, the lithium metal oxide particles may include Co. As a result, the electrical conductivity of the lithium metal oxide particles may be maintained.

In addition, the lithium metal oxide particles may include manganese. Manganese (Mn) may be provided as a metal associated with the mechanical and electrical stability of the lithium secondary battery. For example, manganese may help suppress or reduce defects such as ignition or short circuits that may occur when the cathode is penetrated by an external object, thereby increasing the cycle life of the lithium secondary battery.

According to exemplary embodiments, the lithium metal oxide particles may include nickel, cobalt and manganese. Among metal elements excluding lithium and oxygen oxygen, the molar content of nickel in the lithium metal oxide particles may be greater than the molar contents of cobalt and manganese.

According to exemplary embodiments, the molar fraction of nickel among the metals excluding lithium and oxygen in the lithium metal oxide particles may be 0.8 or more. According to some embodiments, the molar fraction of nickel among the metals excluding lithium and oxygen in the lithium metal oxide particles may be 0.8 or more and less than 1, 0.8 to 0.99, or 0.85 to 0.98. Accordingly, the capacity of a secondary battery including the cathode may be significantly improved.

According to exemplary embodiments, the lithium metal oxide particles may have a layered structure represented by Formula 1 below.

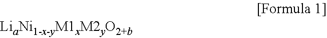

In Formula 1 above, M1 may include at least one of Co and Mn. M2 may include at least one selected from the group consisting of Al, Ti, Ba, Zr, Si, B, Mg, P, Sr and W, and may serve as a doping metal. In Formula 1, a, x, y and b may satisfy 0.9≤a≤1.1, 0≤x≤0.5, 0<y≤0.01, and −0.5≤b≤0.5.

In some embodiments, M1 may include Co and Mn.

In some embodiments, M2 may include Zr.

In some embodiments, a, x, y and b may satisfy 0.9≤a≤1.1, 0≤x≤0.2, 0<y≤0.05, and −0.5≤b≤0.5.

The doping metal may include, for example, Al, Ti, Ba, Zr, Si, B, Mg, P, Sr, W, Y, etc. These may be used alone or in combination of two or more thereof. In some embodiments, the doping metal may include at least one of Ti, Ba, Zr, Si, Mg, Sr, W and Y to improve efficiency and long cycle life performance. For example, the doping metal may include Zr.

The doping metal may be incorporated into the layered structure of the lithium metal oxide to form a chemical bond.

The doping metal may be contained in the lithium metal oxide in a relatively small amount to adjust the activation energy of the cathode to an appropriate level. Accordingly, a high-capacity and high-cycle life secondary battery may be implemented.

In addition, the doping metal may improve the crystal structure stability of the lithium metal oxide. For example, when the lithium metal oxide contains a high content of nickel, the increased instability of the crystal structure may be alleviated. Accordingly, formation of cracks in the cathode active material during repeated charge and discharge cycles may be prevented.

According to exemplary embodiments, the content of the doping metal may be 1000 ppm to 3000 ppm based on the total weight of the lithium metal oxide particles. According to some embodiments, the content of the doping metal may be 1500 ppm to 2000 ppm based on the total weight of the lithium metal oxide particles. Within the above range, the activation energy of the cathode may be adjusted to an appropriate level without altering the layered structure of the lithium metal oxide.

According to exemplary embodiments, the doping metal may be present in the central portion of the lithium metal oxide particles. As described below, a doping metal source may be introduced during a precursor preparation process of the lithium metal oxide particles, and thus, the doping metal may be present in the central portion of the lithium metal oxide particles.

The term “central portion” refers to a region including the center of the particle, wherein the center may be the center of mass or center of volume, and the diameter of the region may be 50% or less of the diameter of the particle.

According to exemplary embodiments, the lithium metal oxide particle may have a secondary particle structure in which a plurality of primary particles are aggregated, and the doping metal may be present at interfaces between the primary particles and within the primary particles.

According to exemplary embodiments, the doping metal may not exhibit a concentration gradient from the central portion to a surface portion of the lithium metal oxide particle. As described below, the doping metal source may be introduced during the precursor preparation process of the lithium metal oxide particle, and thus, the concentration of the doping metal may be substantially uniform from the central portion to the surface portion of the lithium metal oxide particle.

The term “surface portion” may be a region having a predetermined depth from the outer surface of the particle toward the center. The surface portion may have a thickness of 1% to 40% of the particle radius.

The term “substantially uniform” may mean that, even if there is a section where the concentration partially changes, there is no constant trend in the concentration variation, and a difference between the maximum concentration and the minimum concentration is within a range corresponding to experimental error. For example, when the concentration of the doping metal is measured from the central portion to the surface portion of the lithium metal oxide, the difference between the average concentration and the maximum concentration and/or the minimum concentration may be 10% or less of the average concentration.

The central portion and the surface portion of the lithium metal oxide particle may have substantially the same composition. In some embodiments, the lithium metal oxide particle may have substantially the same concentration of metal elements throughout the entire region.

According to exemplary embodiments, the lithium metal oxide particle may have a crystal grain size of 100 nm to 350 nm, as measured by X-ray diffraction (XRD) analysis. In some embodiments, the crystal grain size of the lithium metal oxide particle, as measured by X-ray diffraction (XRD) analysis, may be 150 nm to 350 nm.

Within the above range, the crack resistance of the lithium metal oxide particles may be enhanced, and an increase in the internal resistance of the particles may be prevented.

The term “crystal grain size” as used herein may be measured by X-ray diffraction (XRD) analysis. The crystal grain size may be calculated using the Scherrer equation of Equation 2, based on the full width at half maximum (FWHM) of the peak obtained through XRD analysis.

$$L = \frac{0.9 λ}{β cos θ} \qquad [ Equation 2 ]$$

In Equation 2, L represents the crystal grain size, λ represents the X-ray wavelength, β represents the full width at half maximum of the corresponding peak, and θ represents the diffraction angle. In some embodiments, the full width at half maximum in the XRD analysis for measuring the crystal grain size may be determined from the peak of the (003) plane.

In some embodiments, the XRD analysis is performed on dried powder of the lithium metal oxide particles, using Cu Kα rays as the diffraction light source, within a diffraction angle (2θ) range of 10° to 120°, at a scan rate of 0.0065°/s.

In some embodiments, β in Equation 2 above may use the full width at half maximum corrected for a value derived from equipment. In one embodiment, Si may be used as a standard material for reflecting the equipment-derived value. In this case, by plotting full width at half maximum profiles over the full 2θ range of Si, the equipment-derived full width at half maximum may be represented as a function of 2θ. Thereafter, a corrected value obtained by subtracting the equipment-derived full width at half maximum value at the corresponding 2θ, as obtained from the function, may be used as β.

In some embodiments, the lithium metal oxide particles may have a single-crystal structure or polycrystalline structure in crystallography.

For example, when the lithium metal oxide particle has the single-crystal structure, the lithium metal oxide particle may be composed of one crystal (single crystal). Conversely, when the lithium metal oxide particle has the polycrystalline structure, the lithium metal oxide particle may include two or more crystals.

For example, the single-crystal structure and the polycrystalline structure may be identified based on ion images obtained by analyzing a particle cross-section using a focused ion beam (FIB). For example, when the particle has a polycrystalline structure, two or more single crystals may be observed in the FIB analysis image due to differences in crystal orientation. For example, even if the particle appears as one particle in a scanning electron microscope (SEM) cross-sectional image, it may be observed as a particle composed of two or more crystals in the FIB analysis image.

In exemplary embodiments, the lithium metal oxide may be prepared by the following method.

First, a mixture including a transition metal source, a doping metal source and a solvent may be prepared. The transition metal source may include a nickel source, and may further include a cobalt source and/or a manganese source.

The transition metal source may include a nitrate, a sulfate, an acetate, a hydroxide of nickel, cobalt, and/or manganese, or hydrates thereof, and the doping metal source may include a nitrate, a sulfate, an acetate, a hydroxide of the above-described doping metals, or hydrates thereof.

A molar mixing ratio of the transition metal source and the doping metal source may be adjusted so that the prepared lithium metal oxide has the composition of the above-described Formula 1.

A precipitating agent and/or a chelating agent may be added to the mixture to perform a co-precipitation reaction.

The precipitating agent may include an alkaline compound such as sodium hydroxide (NaOH), sodium carbonate (Na₂CO₃), or the like. The chelating agent may include, for example, aqueous ammonia (e.g., NH₄OH), ammonium bicarbonate (e.g., NH₃HCO₃), and the like

A metal hydroxide including a transition metal and a doping metal may be obtained as a metal precursor through the co-precipitation reaction. Since the metal precursor is prepared by the co-precipitation reaction with the transition metal source and the doping metal source mixed in the solution phase, the doping metal may be present in a central portion of the metal precursor particle. In addition, the doping metal content in the central portion and the surface portion of the metal precursor particle may be substantially the same.

The metal precursor may be mixed with a lithium source and calcined to prepare a lithium metal oxide. The lithium source may include lithium carbonate, lithium nitrate, lithium acetate, lithium oxide, lithium hydroxide, or the like. These may be used alone or in combination of two or more thereof.

The metal precursor and the lithium source may be dry-mixed to form a reaction mixture. The reaction mixture may be calcined to form a lithium metal oxide.

The reaction mixture may be calcined two or more times. For example, the reaction mixture may be first calcined at a relatively low temperature and then second calcined at a relatively high temperature.

The first calcination may be performed, for example, at a temperature of 700° C. to 850° C. for about 1 hour to 5 hours. During the first calcination, the metal precursor and the lithium source may form a layered structure, and a preliminary lithium metal oxide may be prepared.

The preliminary lithium metal oxide may be second calcined to prepare a lithium metal oxide. The second calcination may be performed at a temperature of 850° C. to 950° C. for about 1 hour to 5 hours. Accordingly, the mechanical strength and structural stability of the lithium metal oxide may be further enhanced, and the residual unreacted organic salts may be removed.

The preliminary lithium metal oxide may not be mixed with an additional doping metal source before the second calcination. In this case, the doping metal may not diffuse into the central portion of the lithium metal oxide particle, and the internal stability of the lithium metal oxide particles may be reduced due to a difference in metal composition between the surface portion and the central portion.

The content of the lithium metal oxide particles in the cathode active material layer 110 may be 80% by weight (“wt %”) or more. In some embodiments, the content of the lithium metal oxide particles in the cathode active material layer 110 may be 90 wt % or more.

The cathode active material layer 110 may further include a binder, a conductive material, etc., in addition to the lithium metal oxide particles.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, the amount of the binder for forming the cathode active material layer 110 may be reduced and an amount of the cathode active material may be relatively increased. Thereby, the output and capacity of the secondary battery may be improved.

The conductive material may be included to facilitate electron transfer between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

According to exemplary embodiments, the cathode 100 has an activation energy (Ea) of 62.5 to 66 kJ/mol, as represented by Equation 1 below. According to some embodiments, the cathode 100 has an activation energy (Ea) of 62.5 to 66 kJ/mol, as represented by Equation 1 below.

$$ln {R}^{′} = ln {R}_{0} - \frac{E a}{R} \cdot \frac{1}{T} \qquad [ Equation 1 ]$$

In Equation 1 above, R′ represents the total charge transfer resistance (Rct) obtained by analyzing a half-cell including the cathode and a lithium metal foil counter electrode, modeled as a Randles circuit at two or more different temperatures using electrochemical impedance spectroscopy (EIS). T represents the temperature (K) in the environment at which the EIS analysis is performed. In R₀ and −Ea/R represent the intercept and slope, respectively, derived from a plot of ln R′ versus 1/T according to Equation 1. R₀ represents a constant resistance value independent of temperature, and R represents the gas constant (8.314 J/mol·K).

Electrochemical impedance spectroscopy is a method of analyzing an electrochemical reaction occurring at an electrode by modeling it as an equivalent electrical circuit, such as a Randles circuit. Preferably, the term “Randles circuit” as used herein refers to an equivalent circuit model that represents electrochemical reactions occurring at the interface between the electrode and the electrolyte.

FIG. 2 is a circuit diagram schematically illustrating a Randles circuit according to one embodiment. In FIG. 2, the total charge transfer resistance (Rct) is associated with redox reactions occurring at the electrode surface, the cathode active material layer, a coating layer of the cathode active material, and interfaces between primary particles within a secondary particle, and may represent an impedance indicating the influence of reaction rates and other factors on the resistance of each respective component. The electrolyte resistance (Rs) may represent an impedance corresponding to the resistance of the electrolyte. The electric double-layer capacitance (Cdl) may represent a phenomenon in which charges with opposite polarities accumulate at the interface between the electrode and the electrolyte, forming a charge distribution similar to that of a capacitor. The Warburg impedance (W) is related to the continuous change in the material composition of the electrode surface and the material distribution in the bulk electrolyte along a diffusion layer in an electrochemical reaction, and may represent the migration and diffusion of electrochemically active species (e.g., lithium ions).

For example, each impedance may be measured by modeling the half-cell as a Randles circuit composed of the electrolyte resistance, charge transfer resistance, Warburg impedance, and electric double-layer capacitance.

The total charge transfer resistance may be measured at two or more different temperatures. For example, the charge transfer resistance may be measured at three or more different temperatures.

For the total charge transfer resistance (R′₁, R′₂, R′₃ . . . ) measured at each temperature (T₁, T₂, T₃ . . . ), an Arrhenius plot based on Equation 1 may be fitted, for example, by plotting ln R′ versus 1/T to obtain the slope, from which the activation energy may be calculated.

In R₀ and −Ea/R represent the intercept and slope, respectively, obtained from the plot of ln R′ and 1/T according to Equation 1. That is, ln R₀ may be an intercept that is maintained regardless of the temperature change in the resistance measurement environment and may correspond to the constant term of the Arrhenius plot.

In one embodiment, Equation 1 refers to the Arrhenius equation, and may represent the temperature dependence of the electrode resistance.

For example, R′ represents the sum of all charge transfer resistances (Rct) obtained from the analysis results by electrochemical impedance spectroscopy, and may be an impedance that reflects the influence of the reaction rate and other factors on the resistance associated with redox reactions occurring at the electrode surface. R₀ may represent a temperature-independent resistance constant in the charge transfer resistance (Rct). In addition, R may represent the gas constant (8.314 J/mol·K), and T may represent the absolute temperature (K).

When the activation energy of the cathode is in the range of 62.5 kJ/mol to 66 kJ/mol, the temperature dependence of the electrode resistance may be increased. Therefore, when the battery is operated at a high temperature, the resistance of the electrode may be reduced. As a result, the internal resistance of the cathode may be decreased, thereby improving the output characteristics.

According to exemplary embodiments, the R′ value according to Equation 1 at 283 K may be 40% or less of the R′ value according to Equation 1 at 273 K. According to some embodiments, the R′ value according to Equation 1 at 283 K may be 20% to 38% of the R′ value according to Equation 1 at 273 K.

Within the above range, the resistance value of the cathode at 283 K (about 10° C.) may be reduced, thereby particularly improving the output characteristics of the cathode.

The above-described lithium metal oxide particles may be mixed with a binder, a conductive material, and/or a dispersant in a solvent, and stirred to prepare a slurry. The slurry may be applied to the cathode current collector 105, and then dried and compressed to prepare the cathode 100.

The binder and conductive material may be the same as those described above.

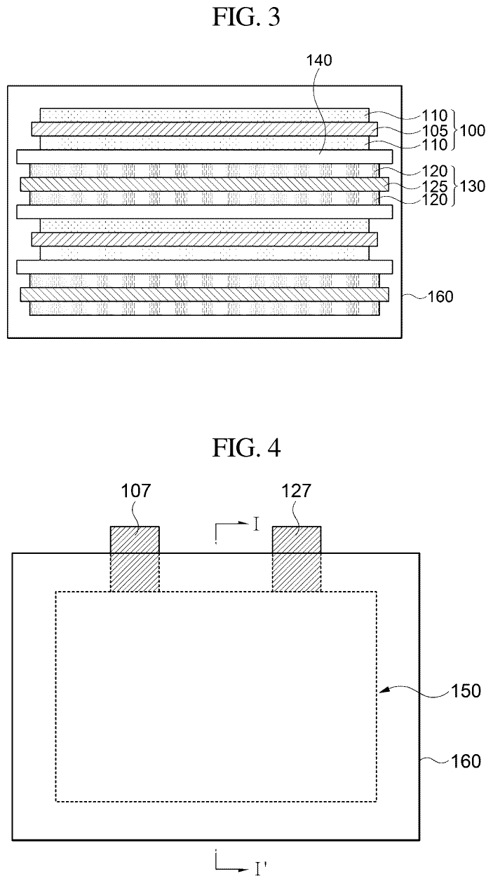

FIGS. 3 and 4 are schematic cross-sectional and plan views, respectively, illustrating a lithium secondary battery according to exemplary embodiments. For example, FIG. 3 is a cross-sectional view taken along line I-I′ of FIG. 4.

Referring to FIG. 3, the lithium secondary battery includes the cathode 100 and an anode 130 disposed opposite to the cathode 100.

According to exemplary embodiments, the anode 130 may include an anode current collector 125 and an anode active material layer 120 formed by coating the anode current collector 125 with an anode active material.

The anode active material may include a material capable of intercalating and deintercalating lithium ions. For example, carbon-based materials such as crystalline carbon, amorphous carbon, carbon slurry, carbon fiber, etc.; a lithium alloy; silicon or tin may be used. Examples of the amorphous carbon may include hard carbon, cokes, mesocarbon microbead (MCMB) calcined at 1500° C. or lower, mesophase pitch-based carbon fiber (MPCF) or the like. Examples of the crystalline carbon may include graphite-based carbon such as natural graphite, graphite cokes, graphite MCMB, graphite MPCF or the like. Other elements included in the lithium alloy may include, for example, aluminum, zinc, bismuth, cadmium, antimony, silicon, lead, tin, gallium, indium or the like.

The anode current collector 125 may include, for example, gold, stainless steel, nickel, aluminum, titanium, copper or alloys thereof, and preferably copper or a copper alloy.

In some embodiments, the anode active material may be mixed with a binder, a conductive material, and/or a dispersant in a solvent, and stirred to prepare a slurry. The slurry may be applied to the anode current collector 125, and then compressed and dried to prepare the anode 130.

As the binder and the conductive material, materials which are substantially the same as or similar to the above-described materials may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

A separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane may include a nonwoven fabric made of glass fibers having a high melting point, polyethylene terephthalate fibers, etc.

In some embodiments, the anode 130 may have an area (e.g., a contact area with the separation membrane 140) and/or volume larger than those/that of the cathode 100. Thereby, lithium ions generated from the cathode 100 may smoothly migrate to the anode 130 without being precipitated during the migration process, for example. As a result, the effects of simultaneously improving output and stability through the use of the above-described cathode active material may be more easily achieved.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding, stacking, z-folding, stack-folding, etc. the separation membrane 140.

The electrode assembly 150 may be housed in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination of two or more thereof.

Electrode tabs may be formed from the cathode current collector 105 and the anode current collector 125, each belonging to a respective electrode cell, and may extend to one side of the case 160. The electrode tabs may be welded together with the one side of the case 160 to form electrode leads (cathode lead 107 and anode lead 127) that extend from or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of Lithium Metal Oxide Particles

NiSO₄, CoSO₄, MnSO₄, and ZrSO₄ were introduced into distilled water, from which dissolved oxygen had been removed by bubbling N₂ for 24 hours, and mixed at a molar ratio of 0.936:0.05:0.014:0.002. The mixed solution was introduced into a reactor at 50° C., and NaOH and NH₃H₂O were added as a precipitant and a chelating agent. Thereafter, a co-precipitation reaction was performed for 72 hours to obtain Ni_{0.936}Co_{0.05}Mn_{0.014}Zr_{0.002}(OH)₂ as a transition metal precursor. The obtained precursor was dried at 100° C. for 12 hours, and then additionally dried at 120° C. for 10 hours.

Lithium hydroxide and the transition metal precursor were added to a dry high-speed mixer at a ratio of 1.03:1, and uniformly mixed for 20 minutes. The mixture was placed in a calcination furnace, heated to 700° C. at a heating rate of 2° C./min and maintained at that temperature for 4 hours. Subsequently, the mixture was cooled to 500° C. and maintained at that temperature for 12 hours to perform a first calcination, thereby preparing a preliminary lithium metal oxide.

Oxygen was continuously supplied at a flow rate of 10 mL/min during the heating and holding steps. After completion of the first calcination, the mixture was allowed to cool naturally to room temperature.

After natural cooling, the preliminary lithium metal oxide was placed in the calcination furnace, heated to 800° C. at a heating rate of 2° C./min, and maintained at that temperature for 4 hours. Subsequently, the resulting product was cooled to 680° C. and maintained at that temperature for 12 hours to perform a second calcination, thereby preparing a lithium metal oxide.

Oxygen was continuously supplied at a flow rate of 10 mL/min during the heating and holding steps. After completion of the second calcination, the mixture was allowed to cool naturally to room temperature. Then, the calcined product was pulverized and classified to prepare lithium metal oxide particles having the composition of Ni_{0.936}Co_{0.05}Mn_{0.014}Zr_{0.002}O₀₂.

### (2) Manufacture of Half-Cell

The lithium metal oxide particles prepared in (1) above, Denka Black as a conductive material, and PVDF as a binder were mixed at a mass ratio of 94:3:3 to prepare a cathode slurry. Subsequently, the cathode slurry was applied to an aluminum current collector (thickness: 20 μm), dried in an oven for 1 hour, and then pressed three times at a pressure of about 80 t using a high-pressure press to fabricate a cathode. The electrode density of the fabricated cathode was about 3.3 g/cc.

A lithium metal foil (thickness 21 μm) was used as the counter electrode (anode).

As the electrolyte, a solution prepared by dissolving 1 M LiPF₆ in a mixed solvent of EC/EMC/DEC (volume ratio: 25/45/30) was used.

The cathode and anode were punched into circular shapes having diameters of Φ14 and Φ16, respectively, and stacked with a separator (polyethylene, thickness: 25 μm) interposed between the cathode and anode to form an electrode cell. Then, the electrolyte was injected into the electrode cell, followed by allowing sufficient impregnation for 12 hours or more to manufacture a 2016 type coin-half cell.

Formation charge and discharge were performed on the manufactured coin-half cell for two cycles (charging conditions: CC-CV 0.1C 4.3V 0.005C CUT-OFF, discharging condition CC 0.1C 3.0V CUT-OFF).

### (3) Manufacture of Lithium Secondary Battery

The lithium metal oxide particles prepared in (1) above, Denka Black as a conductive material, and PVDF as a binder were mixed at a mass ratio of 98:1:1 to prepare a cathode slurry. Subsequently, the cathode slurry was applied to an aluminum current collector (thickness: 21 μm), dried in an oven for 1 hour, and then pressed at a pressure of about 80 t using a high-pressure press to fabricate a cathode. After roll-pressing, the electrode density of the cathode was adjusted to 3.5 g/cc or more.

An anode slurry was prepared, including 93 wt % of natural graphite as an anode active material, 5 wt % of flake-type graphite (KS6) as a conductive material, 1 wt % of styrene-butadiene rubber (SBR) as a binder, and 1 wt % of carboxymethyl cellulose (CMC) as a thickener. The anode slurry was applied to a copper substrate, then dried and pressed to fabricate an anode.

The cathode and anode fabricated as described above were respectively notched to a predetermined size and stacked with a separator (polyethylene, thickness: 25 μm) interposed between the cathode and the anode to form an electrode cell. Thereafter, tap portions of the cathode and the anode were welded, respectively. The assembly of the welded cathode/separator/anode was placed into a pouch, and three sides of the pouch were sealed, leaving one side open for electrolyte injection (“electrolyte injection side”). At this time, a portion having the electrode tab was included in the sealing part. After injecting the electrolyte through the electrolyte injection side, the remaining electrolyte injection side was also sealed, followed by allowing sufficient impregnation for 12 hours or more to manufacture a lithium secondary battery.

As the electrolyte, a solution prepared by dissolving 1 M LiPF₆ in a mixed solvent of EC/EMC/DEC (25/45/30; volume ratio), then adding 1 wt % of vinylene carbonate (VC), 0.5 wt % of 1,3-propenesultone (PRS), and 0.5 wt % of lithium bis(oxalato) borate (LiBOB) thereto was used.

### Example 2

Lithium metal oxide particles, a half-cell, and a lithium secondary battery were manufactured in the same manner as in Example 1, except that the lithium metal oxide was prepared as follows. NiSO₄, CoSO₄, MnSO₄, and ZrSO₄ were introduced into distilled water, from which dissolved oxygen had been removed by bubbling N₂ for 24 hours, and mixed at a molar ratio of 0.936:0.05:0.014:0.002. The mixed solution was introduced into a reactor at 50° C., and NaOH and NH₃H₂O were added as a precipitant and a chelating agent. Thereafter, a co-precipitation reaction was performed for 72 hours to obtain Ni_{0.936}Co_{0.05}Mn_{0.014}Zr_{0.002}(OH)₂ as a transition metal precursor. The obtained precursor was dried at 100° C. for 12 hours, and then additionally dried at 120° C. for 10 hours.

Lithium hydroxide and the transition metal precursor were added to a dry high-speed mixer at a ratio of 1.03:1, and uniformly mixed for 20 minutes. The mixture was placed in a calcination furnace, heated to 700° C. at a heating rate of 2° C./min and maintained at that temperature for 4 hours. Subsequently, the mixture was cooled to 500° C. and maintained at that temperature for 12 hours to perform a first calcination, thereby preparing a preliminary lithium metal oxide.

Oxygen was continuously supplied at a flow rate of 10 ml/min during the heating and holding steps. After completion of the first calcination, the mixture was allowed to cool naturally to room temperature.

After natural cooling, the preliminary lithium metal oxide was placed in the calcination furnace, heated to 800° C. at a heating rate of 2° C./min, and maintained at that temperature for 4 hours. Subsequently, the resulting product was cooled to 700° C. and maintained at that temperature for 12 hours to perform a second calcination, thereby preparing a lithium metal oxide.

Oxygen was continuously supplied at a flow rate of 10 mL/min during the heating and holding steps. After completion of the second calcination, the mixture was allowed to cool naturally to room temperature. Then, the calcined product was pulverized and classified to prepare lithium metal oxide particles having the composition of Ni_{0.936}Co_{0.05}Mn_{0.014}Zr_{0.002}O₂.

### Comparative Example 1

A half-cell and a lithium secondary battery were manufactured in the same manner as in Example 1, except that the lithium metal oxide was prepared as follows.

Lithium metal oxide particles, a half-cell, and a lithium secondary battery were manufactured in the same manner as in Example 1, except that ZrSO₄ was not during the preparation of the transition metal precursor.

NiSO₄, CoSO₄, and MnSO₄ were introduced into distilled water, from which dissolved oxygen had been removed by bubbling N₂ for 24 hours, and mixed at a molar ratio of 0.936:0.05:0.014. The mixed solution was introduced into a reactor at 50° C., and NaOH and NH₃H₂O were added as a precipitant and a chelating agent. Thereafter, a co-precipitation reaction was performed for 72 hours to obtain Ni_{0.8}Co_{0.1}Mn_{0.1} (OH)₂ as a transition metal precursor. The obtained precursor was dried at 100° C. for 12 hours, and then additionally dried at 120° C. for 10 hours.

Lithium hydroxide and the transition metal precursor were added to a dry high-speed mixer at a ratio of 1.03:1, and uniformly mixed for 20 minutes. The mixture was placed in a calcination furnace, heated to 700° C. at a heating rate of 2° C./min and maintained at that temperature for 4 hours. Subsequently, the mixture was cooled to 500° C. and maintained at that temperature for 12 hours to perform a first calcination, thereby preparing a preliminary lithium metal oxide.

Oxygen was continuously supplied at a flow rate of 10 mL/min during the heating and holding steps. After completion of the first calcination, the mixture was allowed to cool naturally to room temperature.

After natural cooling, the preliminary lithium metal oxide and ZrNO₃ were added to a dry high-speed mixer at a weight ratio of 1:0.002, and uniformly mixed for 20 minutes. The mixture was placed in a calcination furnace, heated to 800° C. at a heating rate of 2° C./min, and maintained at that temperature for 4 hours. Subsequently, the mixture was cooled to 680° C. and maintained at that temperature for 12 hours to perform a second calcination, thereby preparing a lithium metal oxide.

Oxygen was continuously supplied at a flow rate of 10 ml/min during the heating and holding steps. After completion of the second calcination, the mixture was allowed to cool naturally to room temperature. Then, the calcined product was pulverized and classified to prepare lithium metal oxide particles having the composition of LiNi_{0.936}Co_{0.05}Mn_{0.14}Zr_{0.00202}.

### Comparative Example 2

A half-cell and a lithium secondary battery were manufactured in the same manner as in Example 1, except that the lithium metal oxide was prepared as follows.

NiSO₄, CoSO₄, and MnSO₄ were introduced into distilled water, from which dissolved oxygen had been removed by bubbling N₂ for 24 hours, and mixed at a molar ratio of 0.936:0.05:0.014. The mixed solution was introduced into a reactor at 50° C., and NaOH and NH₃H₂O were added as a precipitant and a chelating agent. Thereafter, a co-precipitation reaction was performed for 72 hours to obtain Ni_{0.8}Co_{0.1}Mn_{0.1} (OH)₂ as a transition metal precursor. The obtained precursor was dried at 100° C. for 12 hours, and then additionally dried at 120° C. for 10 hours.

Lithium hydroxide and the transition metal precursor were added to a dry high-speed mixer at a ratio of 1.03:1, and uniformly mixed for 20 minutes. The mixture was placed in a calcination furnace, heated to 700° C. at a heating rate of 2° C./min and maintained at that temperature for 4 hours. Subsequently, the mixture was cooled to 500° C. and maintained at that temperature for 12 hours to perform a first calcination, thereby preparing a preliminary lithium metal oxide.

Oxygen was continuously supplied at a flow rate of 10 mL/min during the heating and holding steps. After completion of the first calcination, the mixture was allowed to cool naturally to room temperature.

After natural cooling, the preliminary lithium metal oxide, ZrNO₃, and SrNO₃ were added to a dry high-speed mixer at a weight ratio of 1:0.002:0.001, and uniformly mixed for 20 minutes. The mixture was placed in a calcination furnace, heated to 800° C. at a heating rate of 2° C./min and maintained at that temperature for 4 hours. Subsequently, the mixture was cooled to 680° C. and maintained at that temperature for 12 hours to perform a second calcination, thereby preparing a lithium metal oxide.

Oxygen was continuously supplied at a flow rate of 10 ml/min during the heating and holding steps. After completion of the second calcination, the mixture was allowed to cool naturally to room temperature. Then, the calcined product was pulverized and classified to prepare lithium metal oxide particles having the composition LiNi_{0.936}Co_{0.05}Mn_{0.14}Zr_{0.002}Sr_{0.001}O₂.

### Comparative Example 3

A half-cell and a lithium secondary battery were manufactured in the same manner as in Example 1, except that the lithium metal oxide was prepared as follows.

NiSO₄, CoSO₄, and MnSO₄ were introduced into distilled water, from which dissolved oxygen had been removed by bubbling N₂ for 24 hours, and mixed at a molar ratio of 0.936:0.05:0.014. The mixed solution was introduced into a reactor at 50° C., and NaOH and NH₃H₂O were added as a precipitant and a chelating agent. Thereafter, a co-precipitation reaction was performed for 72 hours to obtain Ni_{0.8}Co_{0.1}Mn_{0.1} (OH)₂ as a transition metal precursor. The obtained precursor was dried at 100° C. for 12 hours, and then additionally dried at 120° C. for 10 hours.

Lithium hydroxide and the transition metal precursor were added to a dry high-speed mixer at a ratio of 1.03:1, and uniformly mixed for 20 minutes. The mixture was placed in a calcination furnace, heated to 700° C. at a heating rate of 2° C./min and maintained at that temperature for 4 hours. Subsequently, the mixture was cooled to 500° C. and maintained at that temperature for 12 hours to perform a first calcination, thereby preparing a preliminary lithium metal oxide.

Oxygen was continuously supplied at a flow rate of 10 ml/min during the heating and holding steps. After completion of the first calcination, the mixture was allowed to cool naturally to room temperature.

After natural cooling, the preliminary lithium metal oxide, ZrSO₄, and Mg (NO₃) 2 were added to a dry high-speed mixer at a weight ratio of 1:0.002:0.001, and uniformly mixed for 20 minutes. The mixture was placed in a calcination furnace, heated to 800° C. at a heating rate of 2° C./min, and maintained at that temperature for 4 hours. Subsequently, the mixture was cooled to 680° C. and maintained at that temperature for 12 hours to perform a second calcination, thereby preparing a lithium metal oxide.

Oxygen was continuously supplied at a flow rate of 10 ml/min during the heating and holding steps. After completion of the second calcination, the mixture was allowed to cool naturally to room temperature. Then, the calcined product was pulverized and classified to prepare lithium metal oxide particles having the composition of LiNi_{0.936}Co_{0.05}Mn_{0.14}Zr_{0.002}Mg_{0.001}O₂.

### Experimental Example

The characteristics of the half-cells or lithium secondary batteries of the examples and comparative examples were evaluated according to the following experimental examples. The experimental results are shown in Table 2 below.

### (1) Calculation of Activation Energy

After charging the half-cells prepared in (2) above according to the examples and comparative examples to 100% SOC, the temperature (T) was adjusted from 273K to 298K in a chamber, and the charge transfer resistance (Rct) at each temperature was measured using electrochemical impedance spectroscopy. The half-cell was modeled as a Randles circuit, and the measured resistance values were converted into the Arrhenius plot according to Equation 1. Then, the activation energy (Ea) was calculated from the slope of the 1/T versus ln R′ plot.

### (2) Measurement of Crystal Grain Size

The lithium metal oxide particles of the examples and comparative examples were sampled. The sampled lithium metal oxide particles were analyzed by X-ray diffraction (XRD) to measure the crystal grain size (S_{XRD}).

The equipment and conditions used for XRD analysis are listed in Table 1 below.

TABLE 1
XRD(X-Ray Diffractometer) EMPYREAN

| Maker | PANalytical | |
|---|---|---|
| Anode material | Cu | |
| K-Alphal wavelength | 1.540598 | Å |
| Generator voltage | 45 | kV |
| Tube current | 40 | mA |

| | |
|---|---|
| Scan Range | 10-120° |
| Scan Step Size | 0.0065° |
| Divergence slit | ¼° |
| Antiscatter slit | ½° |

### (3) Evaluation of Charge and Discharge Efficiency

The lithium secondary batteries prepared in (3) above according to the examples and comparative examples were each charged once (CC-CV 1C 4.2V 0.05C CUT-OFF) and discharged once (CC 1C 2.7V CUT-OFF) in a 45° C. chamber, and their initial charge and discharge capacities were measured, respectively. The charge/discharge efficiency was calculated as the percentage of the discharge capacity relative to the charge capacity.

### (4) Evaluation Cycle Life Characteristic

The lithium secondary batteries prepared in (3) above according to the examples and comparative examples were subjected to 400 repeated cycles of charging (CC-CV 1C 4.2V 0.05C CUT-OFF) and discharging (CC 1C 2.7V CUT-OFF) in a 45° C. chamber, and then the discharge capacity was measured.

The capacity retention rate was calculated as the percentage of the discharge capacity after 400 cycles relative to the initial discharge capacity measured in (3) above.

### (5) Measurement of Doping Metal Loss

The Zr content in the lithium metal oxide particles of the examples and comparative examples was measured by inductively coupled plasma (ICP) spectroscopy. After 500 cycles conducted under the same conditions described in (4) above, the cathode was dissolved by heating it with hydrochloric acid and hydrogen peroxide added thereto. Then, the Zr content of the sample was measured. The measurement results are shown in Table 3.

TABLE 2

| | | | | | | Charge/discharge | | | Cycle life |
|---|---|---|---|---|---|---|---|---|---|
| | | | | | | efficiency evaluation | | | characteristics |
| | | | | | Crystal | | | Charge/ | Capacity |
| | Activation energy calculation | | | | grain | Charge | Discharge | discharge | retention rate |
| | 25° C. | 10° C. | 0° C. | Eₐ | size | capacity | capacity | efficiency | (400 cycles) |
| | (298 K) | (283 K) | (273 K) | (kJ/mol) | (nm) | (mAh/g | (mAh/g) | (%) | (%) |
| Example 1 | 10 | 37 | 104 | 64.368 | 109 | 247.9 | 227.9 | 91.9 | 86 |
| Example 2 | 10 | 37 | 98 | 62.796 | 113 | 247.0 | 226.0 | 91.7 | |
| Comparative | 12 | 49 | 125 | 62.391 | 121 | 246.8 | 219.7 | 89 | 83 |
| Example 1 | | | | | | | | | |
| Comparative | 3 | 12 | 29 | 66.335 | 112 | 248.7 | 226.4 | 91.0 | — |
| Example 2 | | | | | | | | | |
| Comparative | 3 | 12 | 26 | 60.969 | 114 | 244.8 | 220.6 | 90.1 | —- |
| Example 3 | | | | | | | | | |

TABLE 3

| | | | Comparative | Comparative | Comparative |
|---|---|---|---|---|---|
| | Example 1 | Example 2 | Example 1 | Example 2 | Example 3 |
| Initial Zr | 1800 | 1720 | — | 1780 | 1750 |
| content (ppm) | | | | | |
| Zr content | 1790 | — | — | 1420 | — |
| (ppm) after | | | | | |
| 500 cycles | | | | | |
| conducted at | | | | | |
| high | | | | | |
| temperature | | | | | |

Referring to Table 2 above, the cathodes included in the batteries of the examples had an activation energy in the range of 62.5 to 66 kJ/mol, which led to improvements in both charge/discharge efficiency and the capacity retention rate of the batteries.

In the batteries of the comparative examples, which included cathodes having an activation energy of less than 62.5 kJ/mol or greater than 66 kJ/mol, the charge/discharge efficiency decreased slightly or the capacity retention rate deteriorated, and thus the cycle life characteristics were not improved.

In addition, referring to Table 3 above, in the battery of Example 1, the zirconium loss from the cathode active material was only about 10 ppm, indicating that the crystal structure and composition of the lithium metal oxide remained substantially unchanged. On the other hand, in the battery of Comparative Example 2, the zirconium loss from the cathode active material was significantly higher, at about 360 ppm.

The lithium metal oxide of Example 1 included zirconium in the particle core, which minimized the zirconium loss, whereas the lithium metal oxide of Comparative Example 2 included zirconium at the particle interface, resulting in increased zirconium loss.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A cathode for a secondary battery comprising:
a cathode current collector; and
a cathode active material layer disposed on at least one surface of the cathode current collector and comprising lithium metal oxide particles containing a doping metal,
wherein the cathode has an activation energy (Ea) of 62.5 to 66 kJ/mol, as represented by Equation 1 below:
$$ln {R}^{′} = ln {R}_{0} - \frac{E a}{R} \cdot \frac{1}{T} \qquad [ Equation 1 ]$$
(in Equation 1 above, R′ represents the total charge transfer resistance (Rct) obtained by analyzing a half-cell comprising the cathode and a lithium metal foil counter electrode, modeled as a Randles circuit at two or more different temperatures using electrochemical impedance spectroscopy (EIS),
T represents the temperature (K) in the environment at which the EIS analysis is performed,
In R₀ and −Ea/R represent the intercept and slope, respectively, derived from a plot of ln R′ versus 1/T according to Equation 1,
R₀ represents a constant resistance value independent of temperature, and R represents the gas constant (8.314 J/mol·K)).

2. The cathode for a secondary battery according to claim 1, wherein the doping metal comprises at least one selected from the group consisting of Al, Ti, Ba, Zr, Si, B, Mg, P, Sr, W and Y.

3. The cathode for a secondary battery according to claim 1, wherein the doping metal comprises at least one selected from the group consisting of Ti, Ba, Zr, Si, Mg, Sr, W and Y.

4. The cathode for a secondary battery according to claim 1, wherein the content of the doping metal is 1000 ppm to 3000 ppm based on the total weight of the lithium metal oxide particles.

5. The cathode for a secondary battery according to claim 1, wherein the lithium metal oxide particles comprise nickel, and
the molar fraction of nickel among metals excluding lithium and oxygen in the lithium metal oxide particles is 0.8 or more.

6. The cathode for a secondary battery according to claim 1, wherein the lithium metal oxide particles have a layered structure represented by Formula 1 below: 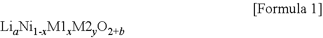
(in Formula 1 above, M1 comprises at least one of Co and Mn, and M2 comprises at least one selected from the group consisting of Al, Ti, Ba, Zr, Si, B, Mg, P, Sr, and W, and a, x, y and b satisfy 0.9≤a≤1.1, 0≤x≤0.2, 0<y≤0.01, and −0.5≤b≤0.5).

7. The cathode for a secondary battery according to claim 1, wherein the doping metal is present in a central portion of the lithium metal oxide particle.

8. The cathode for a secondary battery according to claim 7, wherein the doping metal does not exhibit a concentration gradient from the central portion to a surface portion of the lithium metal oxide particle.

9. The cathode for a secondary battery according to claim 1, wherein the lithium metal oxide particle has a crystal grain size of 100 nm to 200 nm, as measured by X-ray diffraction (XRD) analysis.

10. The cathode for a secondary battery according to claim 1, wherein the R′ value according to Equation 1 at 283 K is 40% or less of the R′ value according to Equation 1 at 273 K.

11. The cathode for a secondary battery according to claim 1, wherein the R′ value according to Equation 1 at 283 K is 20% to 38% of the R′ value according to Equation 1 at 273 K.

12. A lithium secondary battery comprising:
a cathode according to claim 1; and
an anode disposed opposite to the cathode.
